(19) United States
(12) Patent Application Publication
(10) Pub. No.: US 2024/0266685 A1
(43) Pub. Date: Aug. 8, 2024

(54) Battery And Motor Vehicle Having Such A Battery

(71) Applicant: Bayerische Motoren Werke Aktiengesellschaft, Muenchen (DE)

(72) Inventors: Le Bao HUY CHAU, Muenchen (DE); Kevin CZYRKA, Muenchen (DE); Julian EBERLE, Odelzhausen (DE); Manuel KAINZ, Muenchen (DE); Florian PRITSCHER, Landshut (DE); Philipp SCHMIDT, Muenchen (DE); Eva STIEHL, Muenchen (DE); Katharina THANNER, Woerth (DE); Bjoern WAHL, Muenchen (DE); Sascha ZIMMERMANN, Muenchen (DE)

(21) Appl. No.: 18/434,048

(22) Filed: Feb. 6, 2024

(30) Foreign Application Priority Data
Feb. 7, 2023 (DE) 10 2023 102 912.6

(51) Int. Cl. H01M 50/51; H01M 10/48; H01M 50/583

(52) U.S. Cl. CPC H01M 50/51; H01M 10/482; H01M 50/583; H01M 2220/20

(57) ABSTRACT

A battery of a hybrid or purely electrically driven motor vehicle has a first battery element, which includes at least two spatially parallel-running first battery cell strings, which have first battery cells connected in series along a first extension direction of the battery. In addition, the battery has a second battery element, which includes at least two spatially parallel-running second battery cell strings, which have second battery cells connected in series along the first extension direction. The battery is designed in such a way that, for all of the first battery cell strings, it holds true that two consecutive strings of the first battery cell strings are spaced apart from each other along a second extension direction of the battery at least via one of the second battery cell strings.

### CROSS REFERENCE TO RELATED APPLICATION

This application claims priority under 35 U.S.C. § 119 from German Patent Application No. 10 2023 102 912.6, filed Feb. 7, 2023, the entire disclosure of which is herein expressly incorporated by reference.

### BACKGROUND AND SUMMARY

The present invention relates to a battery which is provided, in particular, for a motor vehicle and to a motor vehicle equipped with such a battery.

From the prior art, for example from DE 10 2016 213 081 A1, it is known to construct conventional batteries as so-called multi-string systems, wherein the strings are spatially arranged and/or electrically interconnected based on geometric aspects, for example packaging specifications. In highly integrated high-voltage systems, that is to say if the battery is at least partially used as a traction battery, battery cells of the battery are spatially arranged particularly close to each other. In conventional multi-string systems, it may be that the battery has an area, in particular on a battery terminal block (by means of which the battery is connected or is able to be connected to an electrical conductor network of the motor vehicle), in which a high voltage potential prevails between the strings and in this case the strings are arranged particularly close to each other. In the event of a short circuit, for example due to production faults (dust, etc. between the battery cells or strings), a thermal runaway of a battery cell or an accident, a particularly high electrical energy is released into such an area, which can result, in particular, in an undesirable arc between the battery cells or strings. This causes serious damage to the battery, as the damaged area travels to the battery due to the particularly high electrical energy that is released, especially the particularly strong heat of the arc. The battery module 1 of DE 10 2016 213 081 A1, for example, has such an area between the battery cells BZ1 and BZ2 shown there.

The object of the invention is to improve the safety of a battery, in particular a multi-string battery.

This object is achieved by the subjects of the independent patent claims. Further possible configurations of the invention are disclosed in the dependent claims, the description and the figures. Features, advantages and possible configurations that are presented as part of the description for one part of the subject matter of the independent claims should be considered, across categories and embodiments, at least analogously, to be features, advantages and possible configurations of the respective subject matter of the other independent claims and of every possible combination of the subject matter of the independent claims, optionally in conjunction with one or more of the dependent claims.

The invention proposes a battery and a motor vehicle comprising the battery. The battery forms a component part of the motor vehicle in the intended installation position. The battery is used in the motor vehicle, for example, as a traction battery in and/or for an electric drive train of the motor vehicle, which means that the motor vehicle is a hybrid or purely electrically driven/moving motor vehicle. As an alternative or in addition, the battery may be used on board the motor vehicle for the provision and/or storage of energy for other electrical consumers, for example for interior air conditioning, the operation of comfort and/or assistance systems, etc.

For a simple description of the battery, reference is made herein to a first extension direction and a second extension direction of the battery. In a manner which is not restricting, the first extension direction may be, for example, a longitudinal extension direction (x) of the battery and the second extension direction may be, for example, a transverse extension direction (y) of the battery. The resulting Cartesian coordinate system can correspond to a coordinate system that is fixed with respect to the vehicle, according to DIN 70 000.

The battery comprises two or more battery elements, wherein a first of the battery elements comprises two or more spatially parallel-running first battery cell strings, which have first battery cells along the first extension direction (x) of the battery. The first battery cells are electrically connected in series. A second of the battery elements comprises two or more spatially parallel-running second battery cell strings, which have second battery cells along the first extension direction (x) of the battery. The second battery cells are electrically connected in series. The battery is constructed in such a way that the following holds true for all of the first battery cell strings: two consecutive strings of the first battery cell strings are spaced apart from each other along the second extension direction (y) of the battery at least via one of the second battery cell strings. This inevitably results in the fact that the battery is constructed in such a way that, for all second battery cell strings, it holds true that two consecutive strings of the second battery cell strings are spaced apart from each other along the second extension direction (y) of the battery at least via one of the second battery cell strings. In other words, the battery cell strings are arranged alternately along the second extension direction (y), such that, along the second extension direction, for example, the following arrangement sequence results: first battery cell string—second battery cell string—first battery cell string—second battery cell string—first battery cell string, etc.

If the battery elements or battery cell strings are to be housed in a common installation space, for example in a common battery housing, for example due to packaging specifications, the alternately mixed or alternately arranged battery elements or battery cell strings (as described above) result in an advantageously particularly large distance between battery cells of the first battery element and battery cells of the second battery element. Thus, in the event of a malfunction of one of the battery cells involved, the risk of an arc flashover between one of the first battery cells and one of the second battery cells is advantageously particularly low.

The basic principle of the invention as described thus far can be transferred as desired to batteries comprising three or more battery elements, wherein the distance between the individual battery elements or the distance between the individual battery cell strings/battery cells assigned to the battery elements increases as the number of battery elements increases. Thus, a possible further development of the battery provides that it has one additional battery element or more additional battery elements. This means that the battery comprises three or more battery elements in such a case. The additional battery element is constructed analogously to the first/second battery element: it has at least two spatially parallel-running additional battery cell strings, which have additional battery cells connected in series along the first extension direction (x). It then holds true for the battery that two consecutive strings of the first battery cell strings are spaced apart from each other along the second extension direction (y) of the battery via one of the second battery cell strings and one of the additional battery cell strings. Accordingly, it also holds true for the battery that two consecutive strings of the second battery cell strings are spaced apart from each other along the second extension direction (y) of the battery via one of the first battery cell strings and one of the additional battery strings.

In a possible further development, one of the battery elements is electrically independent of another of the battery elements. For example, if the battery has only the first and the second battery element and no additional battery element, separate batteries are formed by the first battery element and the second battery element from an electrical point of view. If the battery has three or more battery elements, two or more of the battery elements can be interconnected in order to form a battery element assembly from an electrical point of view, wherein one or more of the other battery elements is/are independent of the battery element assembly from an electrical point of view. Furthermore, two battery element assemblies can form electrically independent batteries. As a result thereof, a particularly safe and multifunctional battery is provided, wherein, for example, one or some of the battery elements can be used as a traction battery and the at least one battery element that is independent thereof can be used as a battery for other electrical devices of the motor vehicle. Provision may be made for the battery element or elements used as traction battery to have a different rated voltage (for example, 400 V (volt), 800 V, etc.) than the battery element or elements used for the other electrical devices, which may have, for example, 12 V, 40 V, 60 V as rated voltage.

According to a further possible embodiment, one of the battery elements, for example the first battery element, and another of the battery elements, for example the second battery element, are electrically connected in series and/or connected in parallel with each other by means of a connecting element. In this case, the connecting element has a short-circuit sensor unit, which is designed to detect an electrical short circuit between the battery elements and/or the battery cell strings. The capture or detection of any possible adjacent short circuit can be done by measuring the residual current between the interconnected battery elements. Provision may be made for the short-circuit sensor unit to provide a short-circuit signal when a short circuit is detected. The short-circuit signal can be provided to a control device of the battery and/or of the motor vehicle, wherein the control device is configured to perform a control action associated with the short-circuit signal based on the short-circuit signal. Thus, for example, the battery as a whole or the affected battery cells or the affected battery elements can be deactivated by means of the control device. As an alternative or in addition, the control device can provide a fault message to a user, in particular a driver, of the motor vehicle by means of an associated output device, which is arranged, in particular, in an interior of the motor vehicle equipped with the battery.

A possible further development provides, as part of the battery, in particular as part of the short-circuit sensor unit, a disconnecting device, which is designed to automatically disconnect the battery elements connected to each other by means of the connecting element when an electrical short circuit between the battery elements is detected. This deactivates the area of the battery affected by the short circuit without this requiring any action by the user/driver. This makes the battery even safer.

According to a further possible embodiment, the battery has exactly one short-circuit sensor unit between two of the interconnected battery elements. As a result, the battery described herein differs significantly from conventional batteries in an advantageous manner. In conventional multi-string systems, one conventional short-circuit sensor unit is required for each connection via which two battery cell strings of the battery elements are connected to each other and additionally one conventional short-circuit sensor unit is required for each connection via which two battery elements are connected to each other. By arranging the battery elements or battery elements in conjunction with the exactly one short-circuit sensor unit in alternation, the same degree of safety is ensured by means of the exactly one short-circuit sensor unit between the two interconnected battery elements, in that each adjacent short circuit can be detected and/or disconnected. In this case, the battery advantageously has particularly few electrical/electronic components.

According to another possible embodiment, the battery elements are arranged in a common battery housing of the battery. In other words, two or more battery elements—depending on how many battery elements the battery contains-are grouped together in the battery housing. By arranging the battery elements (and, if necessary, further components of the battery) in the battery housing according to the arrangement described herein, the battery can be used as a particularly compact and, in particular, centralized battery arrangement in the motor vehicle.

Up to this point, a layer of the battery extending in an X-Y plane of the battery has been described. A multi-layer structure of the battery and/or an alternating or alternately arranged arrangement of the battery elements or battery cell strings along a third extension direction, for example, the upward extension direction, of the battery simply emerges from analogous application of the basic principle on which the battery is based. Accordingly, in a further development, the battery may have further layers, wherein first battery cell strings and second battery cell strings are arranged alternately along the third extension direction.

Further features of the invention may emerge from the claims, the figures and the description of the figures. The features and feature combinations mentioned above in the description, and the features and feature combinations below in the description of the figures and/or shown in the figures alone, may be used not only in the respectively specified combination but also in other combinations or individually, without departing the scope of the invention.

### BRIEF DESCRIPTION OF THE DRAWINGS

FIG. 1 is a schematic view of a battery comprising two battery elements, each comprising two or more battery cell strings, and

FIG. 2 is a schematic view of a battery comprising three or more battery elements, wherein the battery elements each comprise two or more battery cell strings.

### DETAILED DESCRIPTION OF THE DRAWINGS

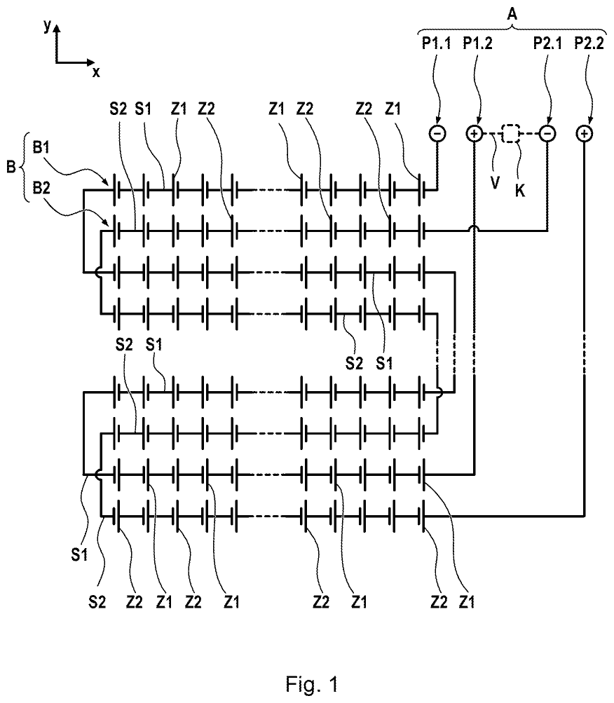

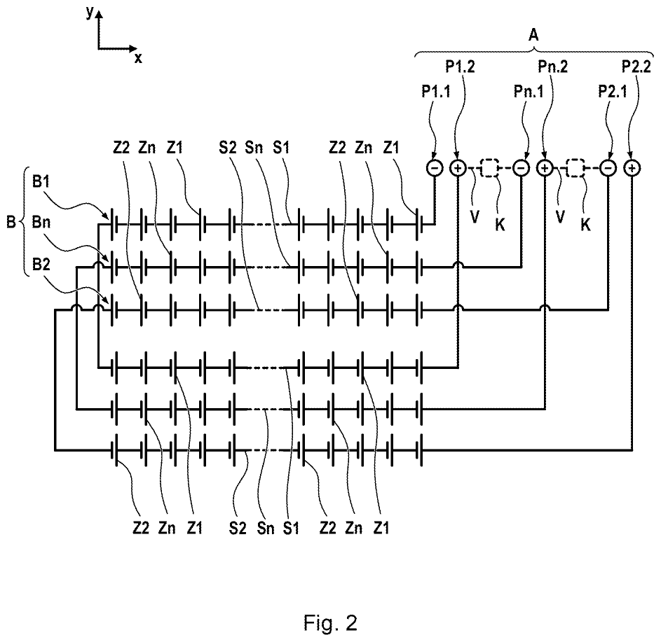

In the following text, a common description is given of a battery B and a motor vehicle (not illustrated) comprising the battery B by way of example. To this end, identical and functionally identical elements are provided with the same reference signs in the figures. FIG. 1 and FIG. 2 are not to be understood exclusively as a circuit diagram; rather, a spatial arrangement of battery elements B1, B2, Bn, which are described in more detail in the following text, is shown at least schematically in the figure.

The battery B forms a component part of the motor vehicle in the intended installation position and is used here in part as a traction battery for an electric drive train of the motor vehicle. Accordingly, the motor vehicle is a hybrid or purely electrically driven/moving motor vehicle. The battery B on board the motor vehicle may also be used for the provision and/or storage of energy for other electrical consumers of the motor vehicle.

FIG. 1 shows that the battery B, for example, has two battery elements B1, B2. The battery element B1, which is denoted here as the first battery element, comprises at least two spatially parallel-running first battery cell lines S1; in the present case, four first battery cell lines S1 are illustrated by way of example, wherein a larger number of first battery cell strings S1 is of course possible. The respective first battery cell string S1 has at least one first battery cell Z1, here a plurality of first battery cells Z1, which are electrically connected in series, along a first extension direction (for example longitudinal extension direction) x of the battery B. In contrast, the battery element B2, which is denoted here as the second battery element, comprises at least two spatially parallel-running second battery cell lines S2; in the present case, four second battery cell lines S2 are illustrated by way of example, wherein a larger number of second battery cell strings S2 is of course possible. The respective second battery cell string S2 has at least one second battery cell Z2, here a plurality of second battery cells Z2, which are electrically connected in series, along the first extension direction x of the battery B. The battery elements B1, B2 each have a correspondingly associated first pole P1.1, P2.1, which is designed here as a negative pole, and a correspondingly associated and opposite second pole P1.2, P2.2, which is designed here as a positive pole. In the present example, the poles P1.1, P1.2, P2.1, P2.2 are arranged spatially on a battery terminal block A of the battery B. The battery elements B1, B2 can have the same rated voltage or different rated voltages. In the present example, the battery B has a battery housing (not illustrated) in which the battery elements B1, B2 and optionally additional battery elements Bn are housed. This means that the battery housing is a housing common to the battery elements B1, B2, Bn.

FIG. 1 furthermore shows that the battery B is constructed in such a way that two successive strings of the first battery cell strings S1 are spaced apart from each other at least via one of the second battery cell strings S2 along a second direction of extension (for example a transverse direction) y of the battery B perpendicular to the first direction of extension. Thus, starting from one of the first battery cell strings S1 for the arrangement of the battery elements B1, B2 along the second extension direction y, the following sequence results: first battery cell string S1—second battery cell string S2—first battery cell string S1—second battery cell string S2, etc. Thus, a distance that at least impedes the formation of an arc between two first battery cells Z1 involved is formed between the two successive battery cell strings S1.

As shown in FIG. 2, this concept can be expanded as desired; the battery B can thus have any number of additional battery elements Bn, wherein the respective additional battery element Bn comprises at least two spatially parallel-running additional battery cell strings Sn. Although only two additional battery cell strings Sn are shown in FIG. 2, a larger number of additional battery cell strings Sn is of course conceivable. The respective additional battery cell string Sn has at least one additional battery cell Zn, here a plurality of additional battery cells Zn, which are electrically connected in series, along the first extension direction x. In addition, the respective additional battery element Bn has a correspondingly associated first pole Pn.1, which is designed here as a negative pole, and a correspondingly associated and opposite second pole Pn.2. The battery B is designed in such a way that two consecutive strings of the first battery cell strings S1 are spaced apart from each other along the second extension direction (y) via one of the second battery cell strings S2 and one of the additional battery strings Sn. Furthermore, two successive strings of the second battery cell strings S2 are spaced apart from each other via one of the first battery cell strings S1 and one of the additional battery cell strings Sn. As a result, a larger distance that impedes the formation of an arc is formed between the two successive battery cell strings S1.

One of the battery elements B1, B2, Bn and another of the battery elements B1, B2, Bn can be electrically independent of each other, that is to say can be two independent or separate electrical energy storage devices. With reference to FIG. 1, this is the case, for example, when the first battery element B1 and the second battery element B2 are electrically isolated from each other. The battery B may also have two independent or separate electrical energy storage devices when two or more of the battery elements B1, B2, Bn, for example the battery elements B1, B2, are connected in parallel or connected in series with each other in order to form a battery element assembly, wherein another of the battery elements B1, B2, Bn, for instance the additional battery element Bn, and this battery element assembly are electrically isolated from each other. Furthermore, the battery B can have two independent or separate electrical energy storage devices when two or more of the battery elements B1, B2, Bn form a first battery element assembly and two or more of the other battery elements B1, B2, Bn form a second battery element assembly, wherein the battery element assemblies are electrically isolated from each other.

FIG. 1 shows in dashed form an optional connecting element V of the battery B, which connecting element has a short-circuit sensor unit K. Two or more of the battery elements B1, B2, Bn can be electrically connected in parallel or connected in series with each other by means of the connecting element V. In this case, the short-circuit sensor unit K is configured, that is to say designed and arranged, to detect an electrical short circuit between the interconnected battery elements B1, B2, Bn and respectively the battery cell strings S1, S2, Sn, in particular by means of a fault current measurement. If three or more of the battery elements B1, B2, Bn are to be electrically connected in parallel or connected in series—see FIG. 2—with each other by means of such a short-circuit sensor unit K, a connecting element V or a short-circuit sensor unit K is provided for each interconnected battery element pair. In particular, exactly one short-circuit sensor unit K is provided for each interconnected battery element pair of the battery B described herein.

The battery B, in particular the respective or the exactly one short-circuit sensor unit K, has in the present case a disconnecting device (not illustrated), which is designed to automatically disconnect the battery elements B1, B2, Bn connected to each other by means of the connecting element V when an electrical short circuit between the battery elements B1, B2, Bn is detected.

The battery B and the motor vehicle comprising the battery B are used to show a particular possibility of how the safety of a battery, in particular a multi-string battery, is improved.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

### LIST OF REFERENCE SIGNS

A Battery terminal block
B Battery
B1 First battery element
B2 Second battery element
Bn Additional battery element
K Short-circuit sensor unit
P1.1 First pole of the first battery element
P1.2 Second pole of the first battery element
P2.1 First pole of the second battery element
P2.2 Second pole of the second battery element
Pn.1 First pole of the additional battery element
Pn.2 Second pole of the additional battery element
S1 First battery cell string
S2 Second battery cell string
Sn Additional battery cell string
V Connecting element
Z1 First battery cell
Z2 Second battery cell
Zn Additional battery cell

What is claimed is:

1. A battery, comprising:
a first battery element, which comprises at least two spatially parallel-running first battery cell strings having first battery cells connected in series along a first extension direction of the battery;
a second battery element, which comprises at least two spatially parallel-running second battery cell strings having second battery cells connected in series along the first extension direction,
wherein, for all of the first battery cell strings, any two consecutive strings of the first battery cell strings are spaced apart from each other along a second extension direction of the battery at least via one of the second battery cell strings.

2. The battery according to claim 1, further comprising
an additional battery element, which comprises at least two spatially parallel-running additional battery cell strings having additional battery cells connected in series along the first extension direction,
wherein, along the second extension direction:
(i) two successive strings of the first battery cell strings are spaced apart from each other via one of the second battery cell strings and one of the additional battery cell strings, and
(ii) two successive strings of the second battery cell strings are spaced apart from each other via one of the first battery cell strings and one of the additional battery cell strings.

3. The battery according to claim 2, wherein
one of the battery elements is electrically independent of another of the battery elements.

4. The battery according to claim 1, wherein
one of the battery elements is electrically independent of another of the battery elements.

5. The battery according to claim 2, wherein
one of the battery elements and another of the battery elements are electrically connected in series and/or connected in parallel with each other via a connecting element, and
the connecting element has a short-circuit sensor unit configured to detect an electrical short circuit between the battery elements.

6. The battery according to claim 5, further comprising:
a disconnecting device configured to automatically disconnect the battery elements connected to each other by the connecting element when an electrical short circuit between the battery elements is detected.

7. The battery according to claim 5, wherein
only one short-circuit sensor unit is provided between two of the interconnected battery elements.

8. The battery according to claim 1,
the battery elements are arranged in a common battery housing of the battery.

9. A motor vehicle comprising a battery according to claim 1.
